(19) United States
(12) Patent Application Publication
(10) Pub. No.: US 2024/0250592 A1
(43) Pub. Date: Jul. 25, 2024

(54) WINDING BASED ON A TYPOLOGY OF A MAGNET-BASED SYNCHRONOUS ROTATING ELECTRIC MACHINE FOR SELF-PROPELLED MOBILE DEVICE

(71) Applicant: VALEO EQUIPEMENTS ELECTRIQUES MOTEUR, Creteil Cedex (FR)

(72) Inventor: Paul ARMIROLI, Creteil Cedex (FR)

(73) Assignee: VALEO EQUIPEMENTS ELECTRIQUES MOTEUR, Creteil Cedex (FR)

(21) Appl. No.: 18/559,414

(22) PCT Filed: May 6, 2022
(86) PCT No.: PCT/EP2022/062309

§ 371 Date: Nov. 7, 2023

(30) Foreign Application Priority Data
May 10, 2021 (FR) 2104915

(51) Int. Cl. H02K 21/12; H02K 3/28; H02K 11/00; H02K 11/049

(52) U.S. Cl. CPC H02K 21/12; H02K 3/28; H02K 11/0094; H02K 11/049; H02K 2213/03

(57) ABSTRACT

A permanent-magnet synchronous rotary electric machine for a self-propelled mobile device includes a stator having slots and a winding including at least three phases. The winding is of the type in which the number of turns N in the stator per phase is equal to the number of conductors in a slot, multiplied by the number P of pole pairs multiplied by the number of slots per pole and per phase, all divided by the number of parallel electrical paths of the conductors in a slot and/or divided by the square root of three if the winding is delta-coupled. The number of turns N per phase in the stator is between 9 and 20.

### TECHNICAL FIELD OF THE INVENTION

The technical field of the invention is that of rotary electric machines such as a starter-alternator or a reversible machine or an electric motor for a self-propelled mobile device.

In the following text, self-propelled mobile device is understood to mean a vehicle for transporting goods or persons which moves autonomously, or an object which moves autonomously, such as a drone.

The invention more particularly relates to the optimization of the winding on the basis of a topology of a synchronous magnet rotary electric machine for the purpose of being supplied with power by an onboard electrical system that has a nominal voltage of between 48 volts and 600 volts.

### TECHNOLOGICAL BACKGROUND OF THE INVENTION

A rotary electric machine comprises a shaft secured to a rotor and a stator, for example arranged surrounding the rotor. The rotor and the stator form an electric motor and interact via a magnetic field. For this, the rotor is provided with permanent magnets and the stator with an electrical winding.

In an electric machine, the stator is usually the armature (where the power conversion takes place). The stator is formed by a three-phase winding which is generally star-coupled or delta-coupled and is composed of multiple electrical phases. The windings are inserted in slots within the yoke made of sheet steel. In the same way, the inductor is generally the rotor, which comprises a winding or permanent magnets for creating the magnetic field. In this instance, use is made of electric machines having magnet rotors, since these rotors exhibit less losses, do not need a winding or brushes, can be more lightweight and make it possible to increase the flux at the rotor with an increase in size.

The market for new self-propelled mobile devices, for example in the moving-vehicle field, fluctuates greatly and imposes various characteristics, which make the definition of standards more complex, for reducing the manufacturing cost.

The various characteristics imposed can be the size, diameter/length, the mechanical power at different speeds (different ranges of rotational speeds and torques) in two operating modes and the direct nominal supply voltage or current of the electric machine that is imposed on it. The nominal supply voltage of the self-propelled mobile device can be a voltage of between 48 volts and very high voltages such as 350 volts. The electric machine therefore moreover comprises an inverter-rectifier for transforming the direct current into alternating current for a multi-phase system. The current can be switched to control the power of the electric motor of the machine.

In the first operating mode, referred to as motor mode, the electrical winding is supplied with electric current via the inverter-rectifier so as to generate a rotating magnetic field at the electrical winding, in order to rotate the rotor synchronously with this rotating field when the rotor is equipped with magnets or coils generating the excitation flux or asynchronously if the rotor is formed of squirrel cages.

In the second operating mode, referred to as generator mode, the rotor is rotated via drive means (combustion engine and/or impeller-propeller) of the self-propelled mobile device (for example in the case of regenerative braking) and the rotation of the rotor equipped with excitation coils or magnets generates a rotating magnetic field at the electrical winding of the stator that is transformed into direct current by the inverter-rectifier which recharges the battery of the vehicle or supplies electrical loads.

Depending on the use of the electric machine, it may be dimensioned, in motor mode, for starting up a combustion engine and/or for providing a “boost”, that is to say assistance to the combustion engine for an acceleration or uphill climb of the vehicle, and/or else to move the vehicle forward in 100% electric mode.

In the event of starting up (combustion engine, or of the vehicle directly in 100% electric mode), the machine must be able to provide a larger torque than in the event of a boost or increase in speed in 100% electric mode.

A winding comprises a group of phases, each phase comprising at least one coil having turns inserted in slots of the stator. A phase may have multiple coils connected in parallel or in series. Each phase group forms a multi-phase, often three-phase, system. The electric machines are designed according to their coupling type: delta coupling or star coupling. This is because the winding will be designed according to the voltage at the output of the inverter-rectifier of the machine, which will be applied differently between one end of a phase and a neutral point or between the two ends of a phase. Specifically, a star coupling involves the connection of one end of a coil of a phase to one end of the inverter-rectifier and then the other end of the set of coils of the phase to a neutral point connecting the phases to one another. The voltage across the terminals of a phase is then reduced (divided by the root of three times the voltage between two phases or voltage applied to the inverter-rectifier). In delta coupling, the winding is designed such that the set of coils of a phase is connected at its two ends to the inverter-rectifier and, on the other hand, to one end of a coil of another phase. The phases are then connecting in series, forming a triangle. This implies that each phase receives the voltage applied by the inverter-rectifier. Depending on the voltage of the inverter-rectifier and the resistance of the coils constituting a phase, which is a function of the number of turns and the cross section of the conductor of the coils selected as a function of the volume of the stator, a delta-coupling winding will be different from a star-coupling winding.

Electric machines such as the one in patent application FR1762641A having 6 phases that form two star-coupled three-phase systems are known. The machine comprises 16 poles, that is to say 8 pole pairs, a number of slots equal to 96, that is to say 1 slot per pole and per phase, and 4 pins per slot, that is to say 32 turns per phase=4*8*1, making it possible to obtain a significant torque at startup, but this torque drops as the speed of the electric machine increases.

The result is a need for optimization in the standardization of an electric machine in order to meet the highly fluctuating needs of electric machines in the field of self-propelled mobile devices.

### SUMMARY OF THE INVENTION

The invention offers a solution to the aforementioned problems by making it possible to standardize synchronous electric machines by adapting the number of turns per phase. The invention aims to adapt the number of turns of a phase, in order to optimize the electric machine by reaching a compromise between limitation of the drop in torque at high speed and at low speed.

One aspect of the invention relates to a permanent-magnet synchronous rotary electric machine for a self-propelled mobile device, comprising a magnet rotor having a number P of pole pairs, a stator comprising slots and a winding comprising at least three phases, each phase has multiple turns, a turn is formed by a succession of electrical conductors accommodated in different slots and electrically connected to one another, each slot accommodating multiple electrical conductors, an inverter-rectifier designed, in motor mode, to transform a DC nominal input voltage comprised between a voltage of 48 volts and a voltage of 600 volts into AC supply voltages of a multi-phase system for each phase of the winding, and designed, in alternator mode, to supply a DC output voltage comprised between a voltage of 48 volts and a voltage of 600 volts. According to the invention, the winding is of the type in which the number of turns N in the stator per phase is equal to the number of conductors in a slot, multiplied by the number P of pole pairs multiplied by the number of slots per pole and per phase, all divided by the number of parallel electrical paths of the conductors for one phase in a slot and/or divided by the square root of three if the winding is delta-coupled, characterized in that the number of turns N per phase in the stator is comprised between 9 and 20.

By virtue of the invention, the electrical machine having a size imposed by the self-propelled mobile device and a maximum inverter-rectifier current imposed for cost and size reasons, the selection of a number of turns N per phase of between 9 and 20 makes it possible to optimize the machine in order to reach a compromise between the limitation of the drop in torque at high speed and at low speed of a synchronous machine in order to be supplied with a nominal voltage of between 48 volts and a very high voltage. This optimization also makes it possible to obtain maximum power of the electric machine. This is because the number of turns N per phase is directly linked to the numbers of phases, poles and conductors in a slot. The number of turns per phase is also a function of the coupling and the nominal voltage of the inverter-rectifier. Thus, by setting this number of turns N per phase in this range, at least one indicator of an electric machine optimized for a self-propelled mobile device, that is to say requiring a starting torque and a mechanical power (in motor mode) that are sufficient at high speed for a volume of the electric machine, is obtained.

The synchronous electric machine exhibits, for example, a drop in power when the machine operates at high speeds that is less significant than for an asynchronous machine. This makes it possible to ensure for example a speed synchronization for the hybridization of a gearbox. Maintaining a power irrespective of the speed makes it possible to go from a low speed to a high speed in less time. A low-speed range corresponds to a speed of between 0 and 4000 rpm in nominal terms and a high-speed range corresponds to a speed greater than 4000 rpm and notably comprised between 4000 rpm and 20 000 rpm.

The number of turns per phase relates to the short-circuit current which relates to the mechanical power of the machine. This is because the short-circuit current Icc is equal to the induced flux divided by the direct synchronous cyclic inductance: Icc=Phi/L.

The inductance L is a function of the number of phase turns: L=N*(dPhi/dI), this showing that Icc is therefore a function of 1/N (where L is the direct synchronous cyclic inductance, Phi is the induced flux).

The short-circuit current is the maximum current acceptable by the machine in a zone of given mechanical power. This current is stable from a number of revolutions of the rotor, for example 1000 rpm for a synchronous machine of 15 kW, 48 volts.

If the number N of turns per phase is greater than 20, the mechanical power will thus be insufficient at high speed, notably for a machine of 48 volts (DC nominal voltage across the terminals of the inverter-rectifier). If the number N is greater than 16, the mechanical power will be insufficient at high speed.

It is also known, in no-load operation, for example in alternator mode, that the field generated by a magnet which moves in front of a conductor gives rise, in this conductor, to an electromotive force of which the value is proportional to the field and to the rotational speed of the magnet and of which the direction is given by the corkscrew rule. As a result, the more turns per phase (number N) there are, the higher the resulting electromotive force is. Specifically, the total electromotive force EMF generated is then equal to the sum of the electromotive forces established in each of the turns of the coil of a phase.

The fewer the number of turns per phase is, the more it is necessary, in motor mode, to compensate the low value of the flux or of the electromotive force EMF by increasing the current in the inverter-rectifier or by way of a flux in the rotor (increase in the size or length of the rotor) in order to have the peak current required at low speeds.

As a result, for imposed machine sizes and an imposed maximum current of the inverter-rectifier, for the reasons explained above, the electromotive force EMF of the machine is therefore proportional to the number of turns per phase of the machine.

If the number N of turns per phase is less than 9, it would lead to an excessively low torque at low speed for a maximum current supplied by an inverter-rectifier or it will then be necessary for the inverter-rectifier and the coil cross sections to be able to allow the circulation of a greater current, leading to other problems, notably thermal problems, or else to an increase in the flux of the rotor, this requiring an increase in the size of the rotor or a change in the magnet type.

This range of the number of turns between 9 and 20 per phase therefore makes it possible to have a balanced synchronous machine: optimum torque and mechanical power for a given size and a minimum inverter-rectifier current.

It will be understood that the number of parallel electric paths is notably the number of groups of turns connected in parallel with one another. Each group may comprise a single turn or multiple turns connected in series.

Besides the features that have just been outlined in the previous paragraph, the electric machine according to one aspect of the invention may have one or more additional features from among the following, which are considered individually or in any technically feasible combination.

According to one embodiment, the electrical conductors accommodated in a slot are arms of a pin, the pins being electrically connected by way of their free ends in pairs so as to form the winding. This makes it possible to increase the amount of copper in a slot and/or to reduce the winding difficulty in relation to a wire winding using a needle device guiding the winding of one and the same electrical wire around each radial tooth in order to form successive turns. Such a winding is referred to as concentric winding or winding with stator turns distributed continuously in the slots.

According to one embodiment, each slot accommodates between 2 and 25 electrical conductors. For example, each slot accommodates between 2 and 4 electrical conductors. The use of 2 or 4 conductors per slot makes it possible to limit the Joule losses at high speeds.

According to one embodiment, one and the same slot can accommodate electrical connectors belonging to one and the same phase or to multiple phases.

According to one embodiment, the number of turns N in the stator per phase is comprised between 9 and 18, and notably between 9 and 16, and the inverter-rectifier has a nominal voltage of 48 volts.

According to an example of this embodiment, the number of turns per phase is comprised between 11 and 12, the number of phases is 6, the number P of pole pairs is comprised between 5 and 6, and the cross section of the conductors is notably dimensioned such that the resistance between two phase outputs is less than 13 milliohms. According to one embodiment of this example, the total cross section of the conductors in a slot is comprised between 18.2 mm² and 27.5 mm². According to one embodiment of this example, the dimensions of a conductor are comprised between 1.9 mm and 3.5 mm in length and between 1.9 mm and 5.3 mm in width. According to one embodiment of this example, the conductors are made of copper and are pins. According to one embodiment of this example, a nominal power of the machine is comprised between 15 KW and 25 kW.

According to another example of this embodiment, the number of turns per phase is comprised between 13 and 18, the number of phases is 3 or 6, the number of pole pairs is comprised between 5 and 6, and the cross section of the conductors is notably dimensioned such that the resistance between two phase outputs is less than 13 milliohms. According to one embodiment of this example, the total cross section of the conductors in a slot is comprised between 19.8 mm² and 24.3 mm². According to one embodiment of this example, the dimension of a conductor is comprised between 0.85 mm and 0.97 mm in diameter. According to one embodiment of this example, the conductors are made of copper and are wound wire. Specifically, it has been noted that, for a wire winding of a 48-volt machine, the number of turns per phase is greater than for a pin winding in order to optimize it, since the amount of copper in a slot is lower than it is for pins.

According to another example of this embodiment, the number of turns per phase is comprised between 16 and 18, the number of phases is 3, and the number P of pole pairs is comprised between 5 and 6.

According to one embodiment, the number of turns per phase is between 16 and 20 and the inverter-rectifier has a DC nominal voltage comprised between 300 and 400 volts.

According to one embodiment, the winding is star-coupled.

According to one embodiment, the winding is delta-coupled.

According to one embodiment, each phase has multiple electrical coils each comprising at least one turn, it being possible for the coils to be connected in series or in parallel.

According to one embodiment, the rotor has a rotor body and a plurality of permanent magnets accommodated in said body.

According to one embodiment, the inverter-rectifier has a DC nominal voltage of 48 volts and the electric machine has a performance ratio equal to the peak torque in Nm multiplied by the peak mechanical power in watts divided by a value equal to the peak current in amperes multiplied by the number of turns per phase N multiplied by the outside diameter of the machine in millimeters multiplied by the length of the machine in millimeters, and wherein the performance ratio is greater than 0.02. It will be understood that the higher the ratio is, the more the machine is optimized.

According to one embodiment, the mechanical power is comprised between 8 KW and 50 KW and the inverter-rectifier is adapted for a DC nominal input voltage of 48 volts.

According to one embodiment, the mechanical power is comprised between 51 KW and 150 KW and the inverter-rectifier is adapted for a DC nominal input voltage of greater than 300 volts.

The invention and its various applications will be better understood upon reading the following description and upon examining the FIGURES accompanying it.

### BRIEF DESCRIPTION OF A FIGURE

FIG. 1 shows an exemplary table for an optimized electric machine. The FIGURE is presented by way of non-limiting indication of the invention.

### DETAILED DESCRIPTION

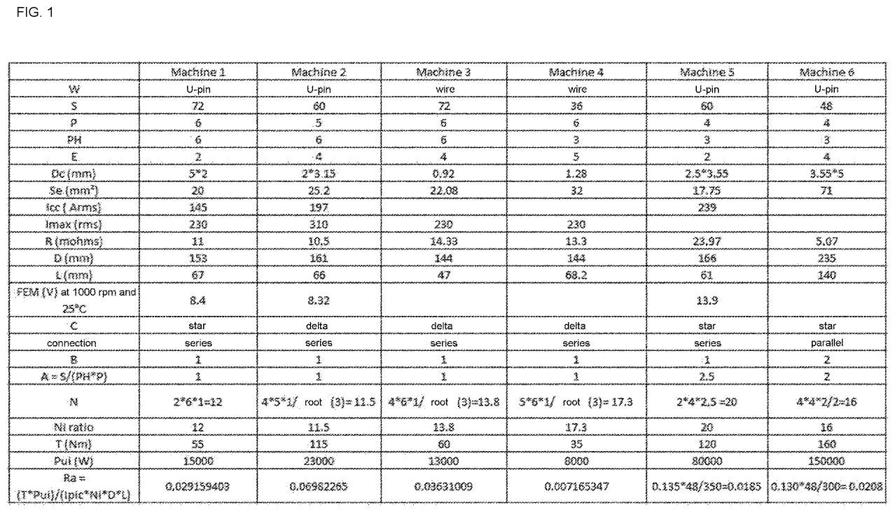

The invention relates to a permanent-magnet synchronous rotary electric machine for a self-propelled mobile device. FIG. 1 shows a table of characteristics of various machines.

The electric machines 1, 2, 3, 4, 5, 6 each comprise a magnet rotor forming an inductor, the number of magnets of which forms a number P of pole pairs. The machines 1, 3 and 4 each comprise 12 poles, whereas the machine 2 has 10 poles and the machines 5 and 6 each have 8 poles.

The electric machines 1, 2, 3, 4, 5, 6 each comprise a stator forming an armature. The stator comprises a yoke forming a component exhibiting symmetry of revolution about an axis passing through the center of the stator. The yoke has radial teeth which extend radially toward the center of the stator and around which an electrical winding is realized. More particularly, the radial teeth delimit slots between them, through which pass electrical conductors which are involved in forming the winding of the stator.

The stators of the electric machines 1, 2, 3, 4, 5, 6 comprise a number of slots S comprised between 36 and 72 slots, in the present case the machines 1 and 3 each comprise seventy-two slots, the machines 2 and 5 comprise sixty slots, the machine 4 comprises thirty-six slots, and the machine 6 comprises forty-eight slots.

The stators of the electric machines 1, 2, 3, 4, 5, 6 each comprise a winding comprising at least three phases PH. The machines 4, 5 and 6 each have three phases, the machines 1, 2, 3 have six phases.

A conductor W in a slot may be formed by an arm of a pin, referred to as U-pin, or a portion of a wire.

In the present case, the machines 1, 2, 5 and 6 each comprise a winding formed by U-pins and the machines 3 and 4 comprise a winding formed by wires. The pins are electrically connected by way of their free ends in pairs in order to form the turns of a phase. This makes it possible to increase the amount of copper in a slot and/or to reduce the difficulty of winding in relation to a wire winding in order to form successive turns.

The conductors of the pins or the wire conductors connected together form a coil or coils. Each coil may comprise multiple revolutions, in other words electrical paths around the axis of rotation, which can be referred to as turns.

The coils of the electric machines 2 and 6 each comprise four copper conductors per slot, the electrical machines 1 and 5 comprise two copper conductors per slot, and the machines 3 and 4 comprise respectively 4 and 5 stator revolutions with 6 or 5 wires in parallel. That is to say the machine 3 has 24 turns per slot and the machine 4 has 25 turns per slot. The number of conductors per slot is referenced E in table 1.

The windings of the phases of the machines 5 and 6 are designed to form a star coupling C, whereas the windings of the phases of the machines 2, 3 and 4 are designed to form a delta coupling.

The electric machines 1, 2, 3, 4, 5, 6 each comprise an inverter-rectifier designed, in motor mode, to transform a DC nominal voltage at the input into supply voltages of a multi-phase system for each phase of the winding of the stator.

The inverter-rectifier of each electric machine 1, 2, 3, 4 is designed to transform a nominal voltage of 48 volts into an AC voltage of a multi-phase system, in the present case for the machines 1, 2, 3 into six voltages, each for one phase of a three-phase system, whereas the inverter-rectifier of the machine 4 transforms the 48 volts into 3 AC voltages for the eight phases.

The inverter-rectifier of each electric machine 5 and 6 is designed to transform a nominal tension of 350 volts and 300 volts, respectively, into a voltage of a multi-phase system, in the present case three voltages of a three-phase system for each of the phases.

Of course, the inverter-rectifier can angularly switch each of the phase voltages to adapt the mechanical power according to a command received from a control unit.

The stator supplied by the inverter-rectifier generating a current of a multi-phase voltage system generates a rotating field in the gap. This magnetic field rotates at a speed of f/P revolutions per second, with f being the supply frequency of the stator windings and P being the number of pole pairs.

The rotor composed of p permanent magnets will then be aligned with the rotating field. The rotor thus rotates at the same speed as the rotating field.

As explained above, the short-circuit current is a function of 1/N, that is to say is inversely proportional to the number N of turns.

The electric machines 1, 2, 3, 4, 5, 6 each have a winding comprising a number of turns N in the stator per phase which is equal to the number E of conductors in a slot, multiplied by the number P of pole pairs multiplied by the number A of slots per pole and per phase, all divided by the number B of parallel electrical paths of the conductors in a slot and/or divided by the square root of three if the winding exhibits a delta coupling C. The number N is an integer if the winding is star-coupled. The number A is equal to the number S divided by the number PH divided by the number P.

In the present case, the number of turns N of the electric machine 1 is therefore an integer and is equal to two conductors multiplied by six pole pairs multiplied by a single slot per phase and per pole (A=72/(6*12)=1), that is to say N=2*6*1=12.

In the present case, the number of turns N of the electric machine 2 is equal to 11.5:4 conductors multiplied by P=five (pole pairs) multiplied by a single slot per phase and per pole (A=60/(6*10)=1), all divided by the root of 3 since the winding is a delta winding: that is to say, N=4*5*1/square root(3)=11.5.

In the present case, the number of turns N of the electric machine 3 is equal to 13.8:4 conductors multiplied by P=six (pole pairs) multiplied by a single slot per phase and per pole (A=72/(6*12)=1), all divided by the root of 3 since the winding is a delta winding: that is to say, N=4*6*1/square root(3)=13.8.

In the present case, the number of turns N of the electric machine 4 is equal to 17.3: E=5 conductors multiplied by P=6 (pole pairs) multiplied by A=1 and all divided by the root of three since the winding exhibits a delta coupling. That is to say, N=5*6*1/square root(3)=17.3.

As a result, it is possible to see that the electric machines having an inverter-rectifier designed for a nominal input voltage of 48 volts comprise a number of turns N comprised between 9 and 18.

In the present case, the integer number of turns N of the electric machine 5 is equal to 20: E=2 conductors multiplied by P=4 multiplied by A=2.5 slots per phase and per pole (60/(3*8)=2.5): that is to say N=2*4*2.5=20.

In the present case, the integer number of turns N of the electric machine 6 is equal to 16: E=4 conductors multiplied by P=four multiplied by A=2 slots per phase and per pole (48/(3*8)=2), all divided by B=2 since 2 conductors are mounted in parallel: that is to say, N=4*4*2/2=16.

As a result, it is possible to see that the electric machines having an inverter-rectifier designed for a nominal input voltage between 300 and 350 volts comprise a number of turns N comprised between 16 and 20.

The winding of each machine therefore has multiple turns in series per phase, in order to increase the resulting electromotive force. The total electromotive force generated is then equal to the sum of the electromotive forces established in each of the turns of the coil.

The machines shown in this table are electric machines which have been optimized for the starting torque and the mechanical power at high speed. As can be seen, for these machines, the number of turns N per phase in the stator per phase is comprised between 9 and 20. Beyond this ratio, either the electric machine comprises a starting torque which is insufficient for a number N of turns per phase of less than 9, or a mechanical power at high speed is too low for a number N of turns per phase of greater than 20.

Lastly, it is also possible to see that a division can be made into two groups: a group of machines having a mechanical power comprised between 15 KW and 50 KW (machines 1 to 4) each have an inverter-rectifier adapted for a DC nominal input voltage of 48 volts and a number of turns per phase N comprised between 9 and 18, and a second group of machines (machines 5 and 6) having a mechanical power comprised between 51 KW and 150 KW have an inverter-rectifier adapted for a DC nominal input voltage of greater than 300 volts and a number of turns per phase N comprised between 16 and 20.

Knowing that the gap is more or less identical for each machine, it follows that the machines of which the inverter-rectifier is adapted to a nominal voltage of 48 volts have a performance ratio Ra making it possible to obtain a torque and maximum power for reduced bulk and a reduced current in the inverter. The ratio Ra is equal to the peak current T multiplied by the peak mechanical power Pui, all divided by a value equal to the peak current Imax multiplied by the number of turns N per phase multiplied by the outside diameter D of the machine multiplied by the length L of the machine. The machines 1, 2, 3, 4 have a performance ratio greater than 0.02.

In the present case, the machine 1 has a peak torque T of 55 Nm multiplied by the peak mechanical power Pui 15 000 watts divided by a value (230*12*153*67=28 292 760 amperes per millimeter squared) equal to the peak current Imax 230 amperes multiplied by the number of turns per phase, N=12, multiplied by the outside diameter (D=153 millimeters) of the machine, multiplied by the length of the machine (L=67 millimeters), that is to say here the ratio Ra is equal to (55*15 000)/(230*12*153*67)=825 000/28 292 760=0.029159.

The machine 2 has a peak torque T of 115 Nm multiplied by the peak mechanical power Pui 23 000 watts divided by a value (310*11.5*161*66=37 881 690 amperes per millimeter squared) equal to the peak current Imax 310 amperes multiplied by the number of turns per phase, N=11.5, multiplied by the outside diameter (D=161 millimeters) of the machine, multiplied by the length of the machine (L=66 millimeters), that is to say here the ratio Ra is equal to 0.069982265.

The machine 3 has a peak torque T of 13.8 Nm multiplied by the peak mechanical power Pui 13 000 watts divided by a value (230*13.8*144*47) equal to the peak current Imax 230 amperes multiplied by the number of turns per phase, N=13.8, multiplied by the outside diameter (D=144 millimeters) of the machine, multiplied by the length of the machine (L=47 millimeters), that is to say here the ratio Ra is equal to 0.03631.

The machine 4 has a peak torque T of 35 Nm multiplied by the peak mechanical power Pui 8000 watts divided by a value (230*17.3*144*68.2) equal to the peak current Imax 230 amperes multiplied by the number of turns per phase, N=17.3, multiplied by the outside diameter (D=144 millimeters) of the machine, multiplied by the length of the machine (L=68.2 millimeters), that is to say here the ratio Ra is equal to 0.00719.

An example of the dimension Dc of the conductors for each machine and an example of the total conductor cross section Se in each slot for each machine will be given below (Se=dimension of the conductors Dc*number of conductors in a slot). It will be understood that these dimensions and cross sections are given by way of example and that a range of variation of plus or minus 5% can be applied to these dimensions without departing from the scope of the invention. For each machine of which the conductor has a rectangular cross section, the width of the conductor can be taken in a substantially radial direction, the length then being taken in a substantially ortho-radial direction, or alternatively the length of the conductor can be taken in a substantially radial direction, the width then being taken in a substantially ortho-radial direction.

The machine 1 may have conductors of rectangular cross section, each having a dimension Dc of 5 mm in length and 2 mm in width. The machine 1 may have a conductor cross section Se in a slot of 20 mm² (5*2*2 conductors per slot).

The machine 2 may have conductors of rectangular cross section, each having a dimension Dc of 3.15 mm in length and 2 mm in width. The machine 2 may have a conductor cross section Se in a slot of 25.2 mm² (3.15*2*4 conductors per slot).

The machine 3 may have conductors of round cross section, each having a dimension Dc of 0.92 mm in diameter. The machine 3 may have a conductor cross section Se in a slot of 22.08 mm² (0.92*24 conductors per slot).

The machine 4 may have conductors of round cross section, each having a dimension Dc of 1.28 mm in diameter. The machine 4 may have a conductor cross section Se in a slot of 32 mm² (1.28*25 conductors per slot).

The machine 5 may have conductors of rectangular cross section, each having a dimension Dc of 3.55 mm in length and 2.5 mm in width. The machine 5 may have a conductor cross section Se in a slot of 17.75 mm² (3.55*2.5*2 conductors per slot).

The machine 6 may have conductors of rectangular cross section, each having a dimension Dc of 5 mm in length and 3.55 mm in width. The machine 6 may have a conductor cross section Se in a slot of 71 mm² (3.55*5*4 conductors per slot).

1. A permanent-magnet synchronous rotary electric machine for a self-propelled mobile device, comprising:
a magnet rotor having a number P of pole pairs,
a stator comprising slots and a winding comprising at least three phases, each phase has multiple turns, a turn is formed by a succession of electrical conductors accommodated in different slots and electrically connected to one another, each slot accommodating multiple electrical conductors,
an inverter-rectifier designed, in motor mode, to transform a DC nominal input voltage comprised between a voltage of 48 volts and a voltage of 600 volts into AC supply voltages of a multi-phase system for each phase of the winding, and designed, in alternator mode, to supply a DC output voltage comprised between a voltage of 48 volts and a voltage of 600 volts,
wherein the winding is of the type in which the number of turns N in the stator per phase is equal to the number E of conductors in a slot, multiplied by the number P of pole pairs multiplied by the number A of slots per pole and per phase, all divided by the number B of parallel electrical paths of the conductors in a slot and/or divided by the square root of three if the winding is delta-coupled, wherein the number of turns N per phase in the stator is comprised between 9 and 20.

2. The electric machine as claimed in claim 1, wherein the electrical conductors accommodated in a slot are arms of a pin, the pins being electrically connected by way of their free ends in pairs so as to form the winding.

3. The electric machine as claimed in claim 1, wherein the number of turns N in the stator per phase is comprised between 9 and 18, and notably between 9 and 16, and the inverter-rectifier has a nominal voltage of 48 volts.

4. The electric machine as claimed in claim 3, wherein the number of turns per phase is comprised between 11 and 12, the number of phases is 6, the number P of pole pairs is comprised between 5 and 6, and the cross section of the conductors is notably dimensioned such that the resistance between two phase outputs is less than 13 milliohms.

5. The electric machine as claimed in claim 3, wherein the number of turns per phase is comprised between 13 and 16, the number of phases is 6, the number P of pole pairs is comprised between 5 and 6, and the cross section of the conductors is notably dimensioned such that the resistance between two phase outputs is less than 13 milliohms.

6. The electric machine as claimed in claim 3, wherein the number of turns per phase is comprised between 16 and 18, the number of phases is 3, and the number P of pole pairs is comprised between 5 and 6.

7. The electric machine as claimed in claim 1, wherein the number of turns per phase is between 16 and 20 and the inverter-rectifier has a DC nominal voltage comprised between 300 and 400 volts.

8. The electric machine as claimed in claim 1, wherein the inverter-rectifier has a nominal voltage of 48 volts and wherein the electric machine has a performance ratio equal to the peak torque in Nm multiplied by the peak mechanical power in watts, all divided by a value equal to the peak current in amperes multiplied by the number of turns per phase N multiplied by the outside diameter of the machine in millimeters multiplied by the length of the machine in millimeters, and wherein the performance ratio is greater than 0.02.

9. The electric machine as claimed in claim 1, wherein the mechanical power is comprised between 8 kW and 50 kW and the inverter-rectifier is adapted for a DC nominal input voltage of 48 volts.

10. The electric machine as claimed in claim 1, wherein the mechanical power is comprised between 51 kW and 150 KW and the inverter-rectifier is adapted for a DC nominal input voltage of greater than 300 volts.

11. The electric machine as claimed in claim 2, wherein the number of turns per phase is between 16 and 20 and the inverter-rectifier has a DC nominal voltage comprised between 300 and 400 volts.

12. The electric machine as claimed in claim 2, wherein the inverter-rectifier has a nominal voltage of 48 volts and wherein the electric machine has a performance ratio equal to the peak torque in Nm multiplied by the peak mechanical power in watts, all divided by a value equal to the peak current in amperes multiplied by the number of turns per phase N multiplied by the outside diameter of the machine in millimeters multiplied by the length of the machine in millimeters, and wherein the performance ratio is greater than 0.02.

13. The electric machine as claimed in claim 2, wherein the mechanical power is comprised between 8 kW and 50 KW and the inverter-rectifier is adapted for a DC nominal input voltage of 48 volts.

14. The electric machine as claimed in claim 2, wherein the mechanical power is comprised between 51 kW and 150 KW and the inverter-rectifier is adapted for a DC nominal input voltage of greater than 300 volts.

15. The electric machine as claimed in claim 3, wherein the inverter-rectifier has a nominal voltage of 48 volts and wherein the electric machine has a performance ratio equal to the peak torque in Nm multiplied by the peak mechanical power in watts, all divided by a value equal to the peak current in amperes multiplied by the number of turns per phase N multiplied by the outside diameter of the machine in millimeters multiplied by the length of the machine in millimeters, and wherein the performance ratio is greater than 0.02.

16. The electric machine as claimed in claim 3, wherein the mechanical power is comprised between 8 kW and 50 KW and the inverter-rectifier is adapted for a DC nominal input voltage of 48 volts.

17. The electric machine as claimed in claim 3, wherein the mechanical power is comprised between 51 KW and 150 KW and the inverter-rectifier is adapted for a DC nominal input voltage of greater than 300 volts.

18. The electric machine as claimed in claim 4, wherein the inverter-rectifier has a nominal voltage of 48 volts and wherein the electric machine has a performance ratio equal to the peak torque in Nm multiplied by the peak mechanical power in watts, all divided by a value equal to the peak current in amperes multiplied by the number of turns per phase N multiplied by the outside diameter of the machine in millimeters multiplied by the length of the machine in millimeters, and wherein the performance ratio is greater than 0.02.

19. The electric machine as claimed in claim 4, wherein the mechanical power is comprised between 8 kW and 50 kW and the inverter-rectifier is adapted for a DC nominal input voltage of 48 volts.

20. The electric machine as claimed in claim 4, wherein the mechanical power is comprised between 51 kW and 150 KW and the inverter-rectifier is adapted for a DC nominal input voltage of greater than 300 volts.
